(19) United States
(12) Patent Application Publication
(10) Pub. No.: US 2024/0326330 A1
(43) Pub. Date: Oct. 3, 2024

(54) MATERIAL DISCHARGE DEVICE AND THREE-DIMENSIONAL MODELING DEVICE

(71) Applicant: SEIKO EPSON CORPORATION, Tokyo (JP)

(72) Inventors: Yasushi KUTSUWADA, MATSUMOTO-SHI (JP); Masaaki OGIHARA, MATSUMOTO-SHI (JP)

(21) Appl. No.: 18/617,411

(22) Filed: Mar. 26, 2024

(30) Foreign Application Priority Data
Mar. 29, 2023 (JP) 2023-052984

(51) Int. Cl. B29C 64/209; B29C 64/393; B33Y 30/00; B33Y 50/02

(52) U.S. Cl. CPC B29C 64/209; B29C 64/393; B33Y 30/00; B33Y 50/02

(57) ABSTRACT

A material discharge device includes a first part including at least a part of a plasticizing unit configured to plasticize a material to generate a plasticized material; a second part including a cylinder configured to communicate with a flow path through which the plasticized material flows, a rod configured to slide in the cylinder, and a nozzle configured to discharge the plasticized material; and a motor fixed to the first part and configured to operate the rod, the first part and the second part are arranged in a first direction, and the rod engages with a drive shaft of the motor in a manner of allowing the rod to move along the first direction.

The present application is based on, and claims priority from JP Application Serial Number 2023-052984, filed Mar. 29, 2023, the disclosure of which is hereby incorporated by reference herein in its entirety.

### BACKGROUND

### 1. Technical Field

The present disclosure relates to a material discharge device and a three-dimensional modeling device.

### 2. Related Art

A material delivery device disclosed in JP-A-2023-3588 includes a first pressure detection unit that detects pressure in a flow path through which a material plasticized by a plasticizing unit flows. A cylinder is coupled to the flow path, and a rod is inserted into the cylinder. The first pressure detection unit detects pressure of a plasticized material in the flow path via the rod.

JP-A-2023-3588 is an example of the related art.

In the device disclosed in the related art, the device may expand due to heat for performing plasticization, and a movement of the rod relative to the cylinder may be hindered due to a displacement of the rod. Such a problem is not limited to the rod for measuring pressure, and the same problem may occur in, for example, a rod for suctioning a material in the flow path or delivering a material into the flow path.

### SUMMARY

According to a first aspect of the present disclosure, a material discharge device is provided. The material discharge device includes: a first part including at least a part of a plasticizing unit configured to plasticize a material to generate a plasticized material; a second part including a cylinder configured to communicate with a flow path through which the plasticized material flows, a rod configured to slide in the cylinder, and a nozzle configured to discharge the plasticized material; and a motor fixed to the first part and configured to operate the rod, the first part and the second part are arranged in a first direction, and the rod engages with a drive shaft of the motor in a manner of allowing the rod to move along the first direction.

According to a second aspect of the present disclosure, a three-dimensional modeling device is provided. The three-dimensional modeling device includes the above-described material discharge device; and a stage disposed in a manner of facing the nozzle.

### BRIEF DESCRIPTION OF THE DRAWINGS

FIG. 1 is a view illustrating a schematic configuration of a three-dimensional modeling device.

FIG. 2 is a view illustrating a schematic configuration of the three-dimensional modeling device.

FIG. 3 is a perspective view illustrating a schematic configuration of a screw.

FIG. 4 is a schematic plan view illustrating a barrel.

FIG. 5 is a side view illustrating the barrel and a flow path block.

FIG. 6 is a perspective view illustrating a heater unit.

FIG. 7 is a view illustrating a state in which the heater unit is coupled to a plasticizing unit.

FIG. 8 is a perspective view illustrating a state in which a first part and a second part are separated from each other.

FIG. 9 is a perspective view illustrating a movable portion and a material discharge device.

FIG. 10 is a side view illustrating the material discharge device.

FIG. 11 is a cross-sectional view illustrating a configuration of a suction mechanism and a pressure detection mechanism.

FIG. 12 is a view illustrating an operation of a first rod.

FIG. 13 is a view illustrating a schematic configuration of an injection molding device according to a second embodiment.

FIG. 14 is a cross-sectional view illustrating a material discharge device and a mold clamping device according to the second embodiment.

### DESCRIPTION OF EMBODIMENTS

### A: First Embodiment

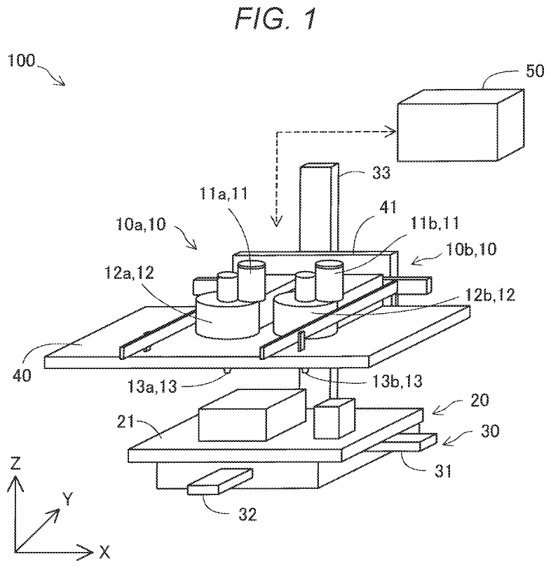

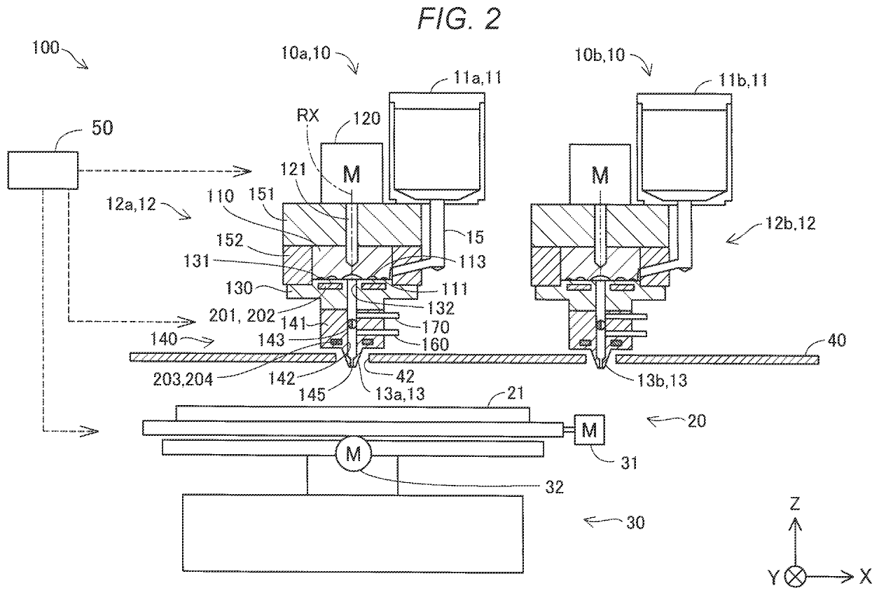

FIGS. 1 and 2 are views illustrating a schematic configuration of a three-dimensional modeling device 100 according to a first embodiment. Arrows indicating X, Y, and Z directions orthogonal to one another are illustrated in FIGS. 1 and 2. The X direction and the Y direction are parallel to a horizontal plane. The Z direction is parallel to a vertical direction. The X, Y, and Z directions in FIGS. 1 and 2 and X, Y, and Z directions in other drawings indicate the same directions. When a direction is specified, a positive direction indicated by an arrow is denoted by “+”, and a negative direction opposite to the direction indicated by the arrow is denoted by “−”, and positive and negative signs are used together in direction notation. The Z direction corresponds to a “first direction”.

The three-dimensional modeling device 100 includes a material discharge device 10, a stage 20, a position changing unit 30, a stage heater 40, and a control unit 50.

The control unit 50 is a control device that controls an overall operation of the three-dimensional modeling device 100. The control unit 50 is implemented by a computer including one or more processors, a memory, and an input and output interface that inputs a signal from and outputs a signal to the outside. The control unit 50 exerts various functions such as a function of executing modeling processing for modeling a three-dimensional object by the processor executing a program or a command read into a main storage device. The control unit 50 may be implemented by a combination of a plurality of circuits for achieving at least a part of the functions, instead of being implemented by a computer.

Under the control of the control unit 50, the material discharge device 10 discharges a plasticized material obtained by plasticizing a material in a solid state into a paste-shaped material onto the stage 20 serving as a base of a three-dimensional object. The material discharge device 10 includes a material supply unit 11, a plasticizing unit 12, and a nozzle 13. The material discharge device 10 is also referred to as a head.

The three-dimensional modeling device 100 includes a first material discharge device 10a and a second material discharge device 10b as the material discharge device 10. The first material discharge device 10a includes a first material supply unit 11a as the material supply unit 11, a first plasticizing unit 12a as the plasticizing unit 12, and a first nozzle 13a as the nozzle 13. The second material discharge device 10b includes a second material supply unit 11b as the material supply unit 11, a second plasticizing unit 12b as the plasticizing unit 12, and a second nozzle 13b as the nozzle 13. The first material discharge device 10a and the second material discharge device 10b are arranged adjacently in the X direction such that positions in the Y direction coincide with each other. The second material discharge device 10b is disposed at a position in the +X direction of the first material discharge device 10a. Since a configuration of the first material discharge device 10a and a configuration of the second material discharge device 10b are the same, hereinafter, the first material discharge device 10a and the second material discharge device 10b may be simply referred to as the material discharge device 10 when the first material discharge device 10a and the second material discharge device 10b are not particularly distinguished from each other. In order to distinguish components of the first material discharge device 10a and the second material discharge device 10b from each other, a reference numeral “a” is added to a component of the first material discharge device 10a and a reference numeral “b” is added to a component of the second material discharge device 10b.

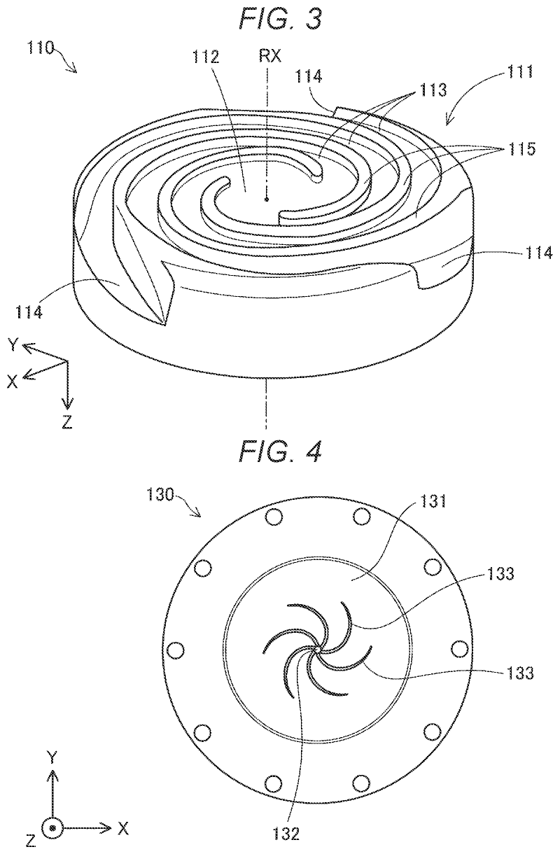

The material supply unit 11 supplies a material for generating a plasticized material to the plasticizing unit 12. The material supply unit 11 is implemented by, for example, a hopper. The material supply unit 11 stores a pellet-shaped or powdery material. As the material, a thermoplastic resin such as polypropylene resin (PP), polyethylene resin (PE), or polyacetal resin (POM) is used. A communication path 15 that couples the material supply unit 11 and the plasticizing unit 12 is provided below the material supply unit 11. The material supply unit 11 supplies a material to the plasticizing unit 12 via the communication path 15. In FIG. 3 and subsequent drawings, the plasticizing unit 12 is omitted as appropriate.

The plasticizing unit 12 plasticizes at least a part of the material supplied from the material supply unit 11, generates a paste-shaped plasticized material having fluidity, and guides the plasticized material to the nozzle 13. Here, the term “plasticize” is a concept including melting, and refers to changing from a solid state to a state having fluidity. Specifically, for a material in which glass transition occurs, the term “plasticize” refers to setting a temperature of the material equal to or higher than a glass transition point. For a material in which glass transition does not occur, the term “plasticize” refers to setting a temperature of the material equal to or higher than a melting point.

The plasticizing unit 12 includes a screw 110, a screw drive motor 120, a barrel 130, and a discharge unit 140.

As illustrated in FIG. 2, the screw 110 is accommodated in a lower case 152. An upper surface of the screw 110 is coupled to the screw drive motor 120 via a drive shaft 121. The screw 110 is rotated integrally with the drive shaft 121 when the screw drive motor 120 applies a drive force to the drive shaft 121. A rotation axis RX of the screw 110 coincides with an axis of the drive shaft 121. An axial direction of the rotation axis RX of the screw 110 is a direction along the Z direction. A rotation speed of the screw 110 is controlled by the control unit 50 controlling a rotation speed of the screw drive motor 120. The screw 110 may be driven by the screw drive motor 120 via a speed reducer. The screw 110 is also referred to as a rotor or a flat screw. The drive shaft 121 is provided in an upper case 151 located above the lower case 152.

The barrel 130 is provided on the −Z direction side of the screw 110. A facing surface 131 that is an upper surface of the barrel 130 faces a groove forming surface 111 that is a lower surface of the screw 110. A communication hole 132 communicating with a flow path 142 of the discharge unit 140 is formed at the center of the barrel 130. First heating units 201 that heat a material supplied to the grooves 113 of the screw 110 to be described later and first detection units 202 that detect temperatures of the grooves 113 of the screw 110 are accommodated in the barrel 130. Details of the barrel 130 will be described later.

FIG. 3 is a perspective view illustrating a schematic configuration of the screw 110. The screw 110 has a substantially cylindrical shape in which a length in a direction along the rotation axis RX is smaller than a length in a direction perpendicular to the rotation axis RX. The grooves 113 having a vortex shape are formed about a central portion 112 in the groove forming surface 111. The grooves 113 communicate with material inlets 114 formed in a side surface of the screw 110. A material supplied from the material supply unit 11 is supplied to the grooves 113 through the material inlets 114. The grooves 113 are formed by being separated by ridge portions 115. Although FIG. 3 illustrates an example in which three grooves 113 are formed, the number of the grooves 113 may be one or two or more. A shape of the grooves 113 is not limited to a vortex shape, and may be a spiral shape or an involute curve shape, or may be a shape extending in an arc from the central portion 112 toward an outer periphery.

FIG. 4 is a schematic plan view illustrating the barrel 130. A plurality of guide grooves 133 are formed about the communication hole 132 in the facing surface 131. One end of each guide groove 133 is coupled to the communication hole 132, and extends in a vortex shape from the communication hole 132 toward an outer periphery of the facing surface 131. The one end of the guide groove 133 may not be coupled to the communication hole 132. Further, the guide groove 133 may not be formed in the barrel 130.

Due to the rotation of the screw 110 and heating of the first heating units 201, a material supplied to the grooves 113 of the screw 110 flows along the grooves 113 while being plasticized in the grooves 113, and is guided to the central portion 112 of the screw 110 as a plasticized material. The paste-shaped plasticized material that exhibits fluidity and flows into the central portion 112 is supplied to the discharge unit 140 through the communication hole 132. In the plasticizing unit, not all kinds of substances constituting the plasticized material may be plasticized. The plasticized material may be converted into a state having fluidity as a whole by plasticizing at least a part of substances constituting the plasticized material.

The discharge unit 140 illustrated in FIG. 2 includes a flow path block 141, the flow path 142, a flow rate adjusting unit 143, a suction mechanism 160, and a pressure detection mechanism 170.

The flow path block 141 is provided on the −Z direction side of the barrel 130. The flow path 142 is formed in the flow path block 141. A second heating unit 203 that heats the flow path block 141 and a second detection unit 204 that detects a temperature of the flow path block 141 are accommodated inside the flow path block 141. Details of the flow path block 141 will be described later.

The nozzle 13 is provided at a lower end of the flow path block 141. The nozzle 13 is coupled to the communication hole 132 of the barrel 130 through the flow path 142. The nozzle 13 discharges the plasticized material generated in the plasticizing unit 12 from a discharge port 145 at a front end of the nozzle 13 toward the stage 20.

The flow rate adjusting unit 143 changes an opening degree of the flow path 142 by being rotated in the flow path 142. The flow rate adjusting unit 143 is implemented by a butterfly valve. The flow rate adjusting unit 143 is controlled by the control unit 50. The control unit 50 adjusts, by controlling a rotation angle of the butterfly valve, a flow rate of the plasticized material flowing from the plasticizing unit 12 to the nozzle 13, that is, a flow rate of the plasticized material discharged from the nozzle 13. The flow rate adjusting unit 143 adjusts a flow rate of the plasticized material and controls ON and OFF of an outflow of the plasticized material. The flow rate adjusting unit 143 may include a shutter mechanism, and may be configured to adjust a flow rate of the plasticized material by changing an opening degree of the flow path 142 by the shutter mechanism.

The suction mechanism 160 is a mechanism for performing a suction operation of suctioning the plasticized material from the flow path 142 and a delivery operation of delivering the suctioned plasticized material to the flow path 142. A tailing phenomenon in which the plasticized material drips in a manner of pulling a thread from the nozzle can be prevented by performing the suction operation. Further, responsiveness of delivery of the plasticized material from the nozzle 13 can be improved by performing the delivery operation. The suction mechanism 160 is controlled by the control unit 50. A specific configuration of the suction mechanism 160 will be described later.

When discharging of the plasticized material from the nozzle 13 is stopped, the control unit 50 first controls the flow rate adjusting unit 143 to turn off the outflow of the plasticized material, and then controls the suction mechanism 160 to suction the plasticized material. When discharging of the plasticized material from the nozzle 13 is restarted, the control unit 50 controls the suction mechanism 160 to deliver the plasticized material suctioned by the suction mechanism 160, and then controls the flow rate adjusting unit 143 to turn on the outflow of the plasticized material.

The pressure detection mechanism 170 is used to detect pressure of the plasticized material in the flow path 142. The control unit 50 detects the pressure of the plasticized material in the flow path 142 using the pressure detection mechanism 170. A specific configuration of the pressure detection mechanism 170 will be described later.

The stage 20 is disposed at a position facing the discharge port 145 of the nozzle 13. The three-dimensional modeling device 100 models a three-dimensional object by discharging the plasticized material from the nozzle 13 toward a modeling surface 21 of the stage 20 and depositing modeling layers.

The position changing unit 30 changes relative positions between the nozzle 13 and the stage 20. In the embodiment, the position changing unit 30 changes the relative positions between the nozzle 13 and the stage 20 by moving the material discharge device 10 along the Z direction which is a depositing direction and moving the stage 20 in a direction intersecting the depositing direction. More specifically, the position changing unit 30 in the embodiment changes the relative positions between the nozzle 13 and the stage 20 in the Z direction by moving the material discharge device 10 along the Z direction, and changes the relative positions between the nozzle 13 and the stage 20 in the X direction and the Y direction by moving the stage 20 along the X direction and the Y direction. As illustrated in FIG. 1, the position changing unit 30 includes a first electric actuator 31 that moves the stage 20 along the X direction, a second electric actuator 32 that moves the stage 20 and the first electric actuator 31 along the Y direction, and a third electric actuator 33 that moves the material discharge device 10 along the Z direction. The third electric actuator 33 moves the first material discharge device 10a and the second material discharge device 10b along the Z direction by moving, along the Z direction, a movable portion 41 to which the first material discharge device 10a and the second material discharge device 10b are fixed. The third electric actuator 33 and the movable portion 41 are omitted in FIG. 2.

The first electric actuator 31, the second electric actuator 32, and the third electric actuator 33 described above are driven under the control of the control unit 50. For example, the position changing unit 30 may move the stage 20 along the Z direction and move the material discharge device 10 along the X direction and the Y direction, may move the stage 20 along the X direction, the Y direction, and the Z direction without moving the material discharge device 10, or may move the material discharge device 10 along the X direction, the Y direction, and the Z direction without moving the stage 20.

The stage heater 40 heats the plasticized material deposited on the stage 20. The stage heater 40 is fixed to the movable portion 41. The stage heater 40 is moved along the Z direction by the third electric actuator 33 together with the material discharge device 10. As illustrated in FIG. 2, the stage heater 40 is provided with an opening 42 that penetrates the stage heater 40 in the Z direction. The nozzle 13 is positioned in the opening 42 when the plasticized material is discharged to model a three-dimensional object, and a front end of the nozzle 13 is disposed between the stage heater 40 and the stage 20 in the Z direction.

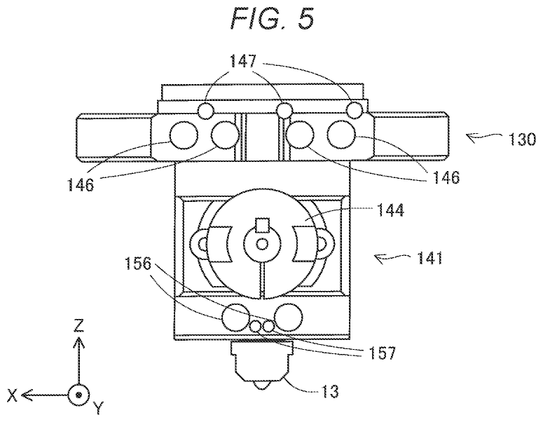

FIG. 5 is a side view illustrating the barrel 130 and the flow path block 141. First holes 146 for accommodating the first heating units 201 and second holes 147 for accommodating the first detection units 202 are formed in the barrel 130. A direction in which the first hole 146 extends coincides with a direction in which the second hole 147 extends. That is, an insertion direction of inserting the first heating unit 201 into the first hole 146 coincides with an insertion direction of inserting the first detection unit 202 into the second hole 147. In the embodiment, the first hole 146 and the second hole 147 extend in the Y direction. In the present specification, the term “coincide” also allows for a state in which the directions do not completely coincide with each other and are slightly inclined. For example, when a diameter of the first hole 146 is larger than a diameter of the first heating unit 201 or a diameter of the second hole 147 is larger than a diameter of the first detection unit 202, the direction in which the first hole 146 extends and the direction in which the second hole 147 extends may be slightly inclined.

In the flow path block 141, third holes 156 for accommodating the second heating units 203 and fourth holes 157 for accommodating the second detection units 204 are formed. A direction in which the third hole 156 extends coincides with a direction in which the fourth hole 157 extends. That is, an insertion direction of inserting the second heating unit 203 into the third hole 156 coincides with an insertion direction of inserting the second detection unit 204 into the fourth hole 157. In the embodiment, the third hole 156 and the fourth hole 157 extend in the Y direction. The direction in which the third hole 156 and the fourth hole 157 extend coincides with the direction in which the first hole 146 and the second hole 147 extend. FIG. 5 illustrates a state in which a coupling 144 for rotating the flow rate adjusting unit 143 is disposed on a side surface of the flow path block 141.

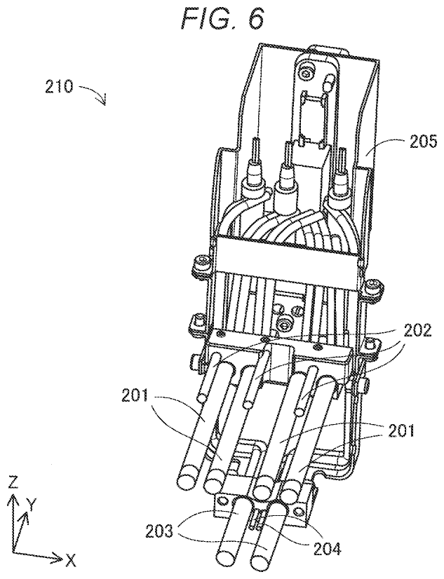

FIG. 6 is a perspective view illustrating a heater unit 210. The heater unit 210 includes the first heating units 201, the first detection units 202, the second heating units 203, the second detection units 204, and a fixing member 205. The first heating unit 201, the first detection unit 202, the second heating unit 203, and the second detection unit 204 each have a cylindrical shape having an axis along the Y direction, and are provided in a manner of protruding from the fixing member 205 in the −Y direction. The first heating unit 201, the first detection unit 202, the second heating unit 203, and the second detection unit 204 are fixed to the fixing member 205, and are coupled by the fixing member 205. The fixing member 205 accommodates wires of the first heating unit 201, the first detection unit 202, the second heating unit 203, and the second detection unit 204. The first heating unit 201 and the second heating unit 203 are, for example, heaters. The first detection unit 202 and the second detection unit 204 are, for example, a thermocouple. The first heating unit 201, the first detection unit 202, the second heating unit 203, and the second detection unit 204 are provided at positions where the first heating unit 201 is inserted into the first hole 146, the first detection unit 202 is inserted into the second hole 147, the second heating unit 203 is inserted into the third hole 156, and the second detection unit 204 is inserted into the fourth hole 157 when the heater unit 210 is coupled to the plasticizing unit 12.

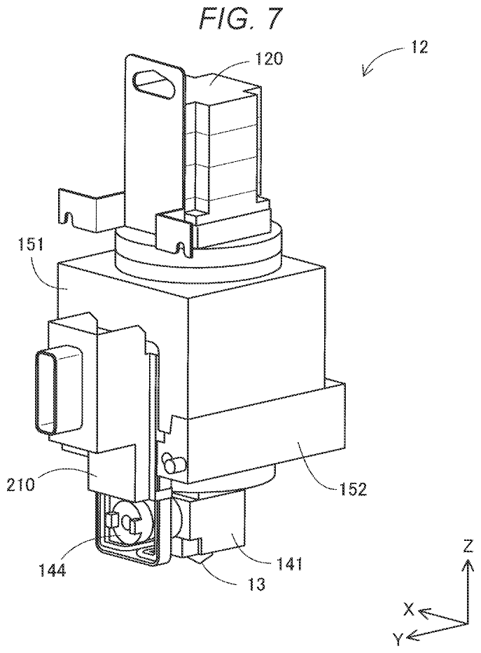

FIG. 7 is a diagram illustrating a state in which the heater unit 210 is coupled to the plasticizing unit 12. The first heating unit 201 is inserted into the first hole 146, the first detection unit 202 is inserted into the second hole 147, the second heating unit 203 is inserted into the third hole 156, and the second detection unit 204 is inserted into the fourth hole 157 by coupling the heater unit 210 to the plasticizing unit 12. That is, the first heating unit 201 and the first detection unit 202 are disposed in the barrel 130, and the second heating unit 203 and the second detection unit 204 are disposed in the flow path block 141 by coupling the heater unit 210 to the plasticizing unit 12.

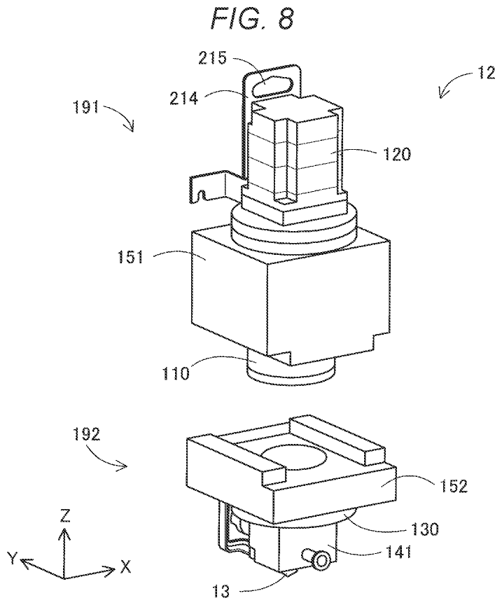

FIG. 8 is a perspective view illustrating the plasticizing unit 12 in a state in which a first part 191 and a second part 192 in the material discharge device 10 are separated from each other. The material discharge device 10 includes the first part 191 and the second part 192. The first part 191 and the second part 192 are arranged in the Z direction. The first part 191 is located on the +Z direction side of the second part. The first part 191 and the second part 192 are configured to be separable in the first direction. The first part 191 includes at least a part of the plasticizing unit 12. Specifically, the first part 191 includes the screw drive motor 120, the drive shaft 121, the upper case 151, and the screw 110. The second part 192 includes the lower case 152, the barrel 130, the flow path block 141, and the nozzle 13. A user can perform maintenance of the screw 110 and the barrel 130 by separating the material discharge device 10 into the first part 191 and the second part 192.

The first part 191 includes a first coupling portion 214. The first coupling portion 214 is provided at an upper end of the material discharge device 10. The first coupling portion 214 is a plate-shaped member having an opening 215, and is fixed to the screw drive motor 120.

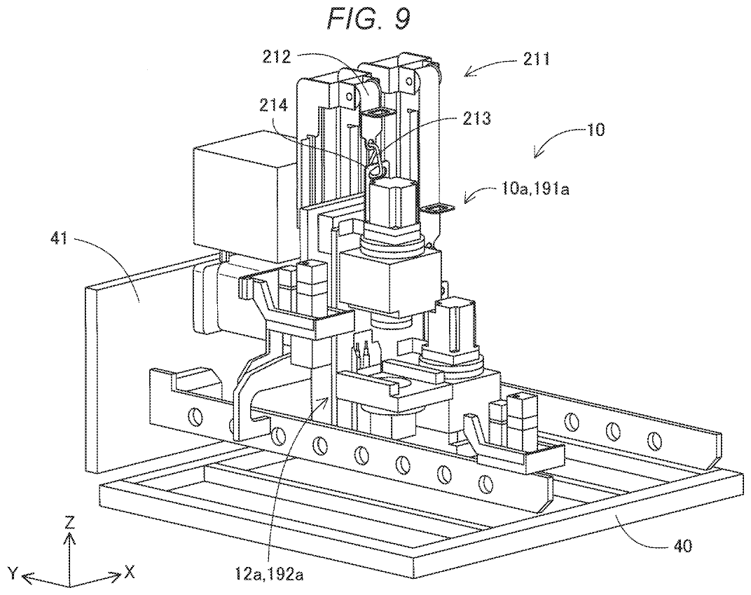

FIG. 9 is a perspective view illustrating the movable portion 41 and the material discharge device 10. A support part 211 is fixed to the movable portion 41. The support part 211 is provided on the +Y direction side and the +Z direction side of the material discharge device 10. The support part 211 suspends the first part 191 of the material discharge device 10. FIG. 9 illustrates a state in which a first part 191a of the first material discharge device 10a is suspended by the support part 211. The support part 211 includes a spring 212 and a second coupling portion 213. The spring 212 is, for example, a plate spring. The spring 212 is preferably a constant load spring. The second coupling portion 213 is a member that is fixed to a lower end of the spring 212 and suspends the first part 191. The second coupling portion 213 is, for example, a hook.

When the first part 191 and the second part 192 are separated from each other, the first part 191 is suspended from the support part 211 by hooking the second coupling portion 213 in the opening 215 of the first coupling portion 214. In this manner, a user can easily maintain the screw 110 and the barrel 130.

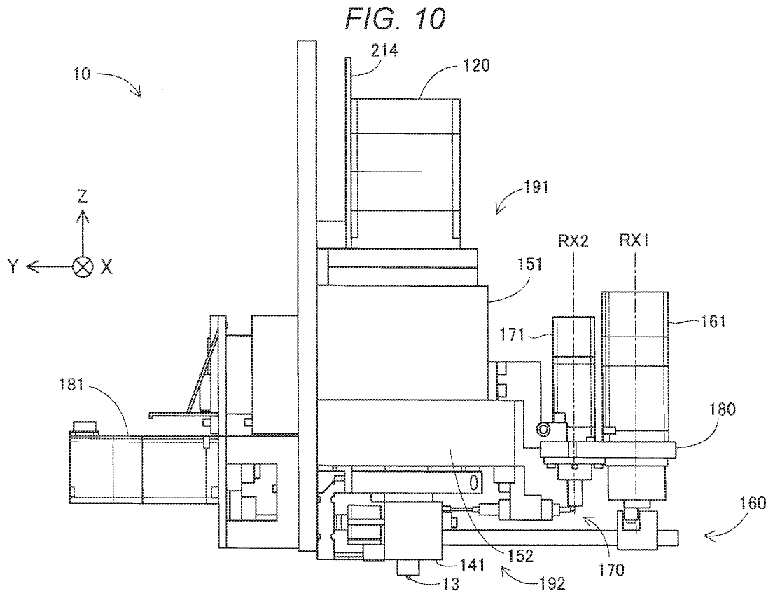

FIG. 10 is a side view illustrating the material discharge device 10. As described above, the material discharge device 10 includes the suction mechanism 160 and the pressure detection mechanism 170. A motor support member 180 is fixed to a side surface on the −Y direction side of the upper case 151 provided in the first part 191. The motor support member 180 supports a first motor 161 used for operating the suction mechanism 160 and a second motor 171 used for operating the pressure detection mechanism 170. The first motor 161 and the second motor 171 are fixed to the first part 191 by the motor support member 180. A rotation axis RX1 of the first motor 161 and a rotation axis RX2 of the second motor 171 extend along the Z direction. A flow rate adjusting motor 181 for rotating the flow rate adjusting unit 143 is provided on an opposite side of the first part 191 and the second part 192 from the suction mechanism 160 and the pressure detection mechanism 170. A rotation force of the flow rate adjusting motor 181 is transmitted to the flow rate adjusting unit 143 provided in the flow path block 141 via the coupling 144.

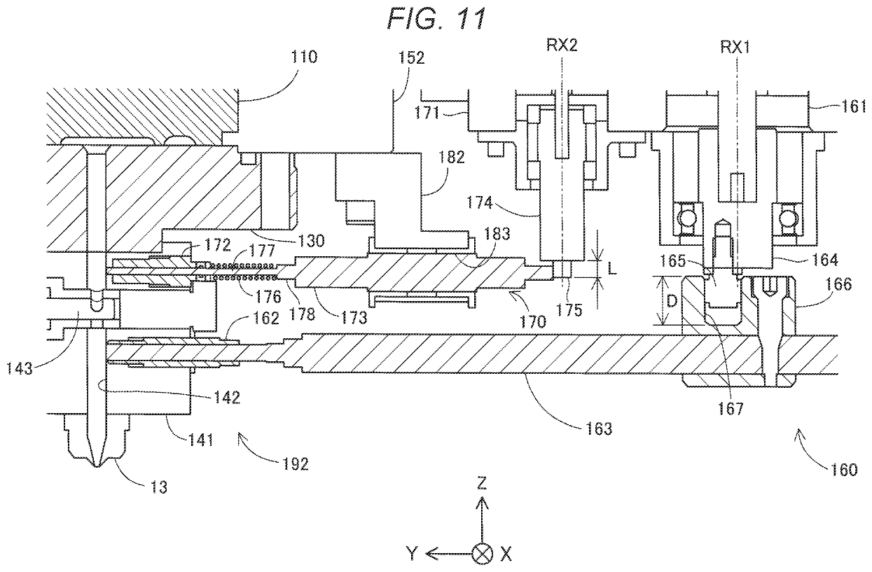

FIG. 11 is a cross-sectional view illustrating a configuration of the suction mechanism 160 and the pressure detection mechanism 170. The suction mechanism 160 includes a first cylinder 162 and a first rod 163. The first cylinder 162 and the first rod 163 are provided in the flow path block 141 in the second part 192. The first cylinder 162 communicates with the flow path 142 through which the plasticized material flows. In the embodiment, the first cylinder 162 communicates with the flow path 142 downstream of the flow rate adjusting unit 143. The first cylinder 162 is provided along the Y direction orthogonal to a direction in which the flow path 142 extends. A front end of the first cylinder 162 is coupled to the flow path 142, and a rear end of the first cylinder 162 is exposed to the outside of the flow path block 141. The first rod 163 slides in the first cylinder 162. A front end portion of the first rod 163 is disposed inside the first cylinder 162, and a rear end portion of the first rod 163 is positioned near a lower side of the first motor 161. The first cylinder 162 is also called a first sleeve, and the first rod 163 is also called a first plunger.

A first drive shaft 164 of the first motor 161 includes a first coupling portion 165 eccentric relative to the rotation axis RX1 of the first drive shaft 164. The first coupling portion 165 is implemented by, for example, a cam follower or a roller follower. The first rod 163 has an engagement portion 166 near a rear end of the first rod 163. In the engagement portion 166, a recessed portion 167 that is recessed along the Z direction and engages with the first coupling portion 165 is formed.

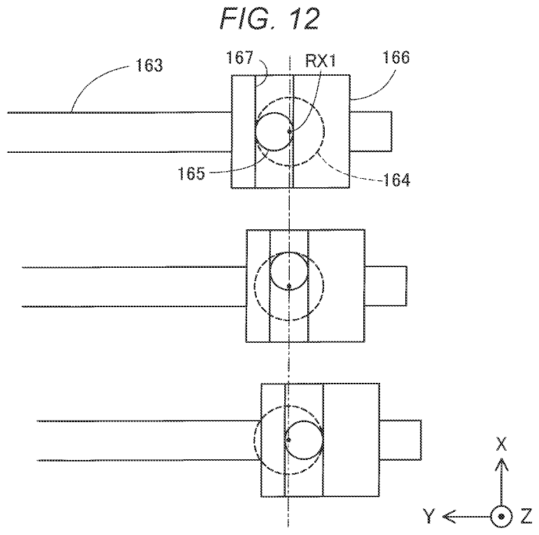

FIG. 12 is a view illustrating an operation of the first rod 163. FIG. 12 illustrates a state in which the first rod 163, the engagement portion 166, and the first coupling portion 165 are viewed in the −Z direction. As illustrated in FIG. 12, the recessed portion 167 is formed in the engagement portion 166 along the X direction.

An upper part of FIG. 12 illustrates a state in which the first coupling portion 165 is eccentric in the +Y direction relative to the rotation axis RX1 of the first drive shaft 164. When the control unit 50 rotates the first drive shaft 164 clockwise by 90 degrees from this state, as illustrated in a central part of FIG. 12, the first coupling portion 165 is rotated around the rotation axis RX1 and is moved in the recessed portion 167, thereby moving the first rod 163 in the −Y direction. When the control unit 50 further rotates the first drive shaft 164 clockwise by 90 degrees, as illustrated in a lower part of FIG. 12, the first coupling portion 165 is moved in the recessed portion 167, thereby further moving the first rod 163 in the −Y direction. The control unit 50 controls the first motor 161 to rotate the first coupling portion 165 formed at the first drive shaft 164 about the rotation axis RX1, thereby causing the first rod 163 to slide in the first cylinder 162 and performing the suction operation and the delivery operation described above.

As illustrated in FIG. 11, a front end portion of the first rod 163 is supported by the first cylinder 162, and a rear end side of the first rod 163 is not supported by the first cylinder 162 in the embodiment. The engagement portion 166 in the first rod 163 is provided with the recessed portion 167 that is opened in the +Z direction, and the first coupling portion 165 that protrudes from the first drive shaft 164 in the −Z direction enters the recessed portion 167. With such a structure, the first rod 163 engages with the first drive shaft 164 of the first motor 161 in a manner of allowing the first rod 163 to move along the Z direction. A depth D of the recessed portion 167 is set to a depth at which the first coupling portion 165 engages with the recessed portion 167 in both a case where the first rod 163 is displaced and a case where the first rod 163 is not displaced in the Z direction due to thermal expansion of the first part 191 and the second part 192. In the embodiment, a displacement amount of the first rod 163 in the Z direction due to thermal expansion of the first part 191 and the second part 192 is a displacement amount of the first rod 163 in the Z direction when the first heating unit 201, the second heating unit 203, and the stage heater 40 are operated at rated maximum temperatures, with a position of the first rod 163 in the Z direction at a room temperature as a reference. The displacement amount is, for example, 300 μm to 500 μm.

The pressure detection mechanism 170 includes a second cylinder 172 and a second rod 173. The second cylinder 172 and the second rod 173 are disposed in the second part 192. The second cylinder 172 communicates with the flow path 142 through which the plasticized material flows. In the embodiment, the second cylinder 172 communicates with the flow path 142 upstream of the flow rate adjusting unit 143. The second cylinder 172 is provided along the Y direction orthogonal to a direction in which the flow path 142 extends. A front end of the second cylinder 172 is coupled to the flow path 142, and a rear end of the second cylinder 172 is exposed to the outside of the flow path block 141. The second rod 173 slides in the second cylinder 172. A front end portion of the second rod 173 is disposed inside the second cylinder 172, and a rear end portion of the second rod 173 is positioned near a lower side of the second motor 171. A central portion of the second rod 173 is inserted into a through hole 183 of a stay 182 fixed to the lower case 152. The second rod 173 can slide in the Y direction in the through hole 183. The second cylinder 172 is also called a second sleeve, and the second rod 173 is also called a second plunger.

A second drive shaft 174 of the second motor 171 includes a second coupling portion 175 eccentric relative to the rotation axis RX2 of the second drive shaft 174. The second coupling portion 175 is implemented by, for example, a cam follower or a roller follower. In FIG. 11, the second coupling portion 175 is eccentric in the +X direction relative to the center of the rotation axis RX2. A rear end of the second rod 173 is in contact with a side surface of the second coupling portion 175 from the +Y direction side. With such a configuration, the second rod 173 engages with the second drive shaft 174 of the second motor 171 in a manner of allowing the second rod 173 to move along the Z direction. A length L of the second coupling portion 175 along the Z direction is set to a length at which the rear end of the second rod 173 is in contact with the side surface of the second coupling portion 175 in both a case where the second rod 173 is displaced and a case where the second rod 173 is not displaced in the Z direction due to thermal expansion of the first part 191 and the second part 192.

The second rod 173 includes a small-diameter portion 177 and a large-diameter portion 178 having a larger diameter than the small-diameter portion 177. The large-diameter portion 178 is located on the −Y direction side of the small-diameter portion 177. The small-diameter portion 177 is inserted into the second cylinder 172. A length of the small-diameter portion 177 is larger than a length of the second cylinder 172. A biasing member 176 is inserted through the small-diameter portion 177. The biasing member 176 is located between the second cylinder 172 and the large-diameter portion 178. The biasing member 176 is, for example, a coil spring. The biasing member 176 biases the second rod 173 in a direction away from the flow path 142. Accordingly, the rear end of the second rod 173 is constantly in contact with the side surface of the second coupling portion 175, and a torque equal to or larger than a predetermined value is constantly applied from the second rod 173 to the second drive shaft 174.

The second motor 171 is operated such that the second rod 173 is held at a predetermined position in the second cylinder 172. A function of implementing such an operation is referred to as a servo lock function. By this operation, the second motor 171 holds a rotation position of the second drive shaft 174 such that the second rod 173 is not moved in the second cylinder 172 by pressure of the plasticized material in the flow path 142. That is, the second motor 171 operates the second rod 173 such that the second rod 173 is not moved by the pressure of the plasticized material. With such an operation, as a force received by the second rod 173 from the flow path 142 and the biasing member 176 increases, a torque applied to the second drive shaft 174 by the second motor 171 increases so as to balance the force. Therefore, the control unit 50 can detect pressure in the flow path 142 according to a torque value of the second motor 171, that is, a current value.

According to the first embodiment described above, the rods 163 and 173 respectively engage with the drive shafts 164 and 174 of the motors 161 and 171 in a manner of allowing the rods 163 and 173 to move along the Z direction. Therefore, even when the rods 163 and 173 are displaced in the Z direction due to the first part 191 and the second part 192 in the material discharge device 10 thermally expanding in the Z direction along with the generation of the plasticized material, operations of the rods 163 and 173 relative to the cylinders 162 and 172 are not hindered by the drive shafts 164 and 174.

In particular, in the embodiment, a depth of the recessed portion 167 of the engagement portion 166 formed at the first rod 163 that engages with the first drive shaft 164 of the first motor 161 is set to a depth at which the first coupling portion 165 engages with the recessed portion 167 in both a case where the first rod 163 is displaced and a case where the first rod 163 is not displaced in a depth direction of the recessed portion 167 due to thermal expansion of the first part 191 and the second part 192. Therefore, even when the first part 191 and the second part 192 thermally expand, the suction mechanism 160 can reliably perform the suction operation and the delivery operation of the plasticized material.

Further, in the embodiment, the first rod 163 and the first drive shaft 164 engage with each other by causing the first coupling portion 165 of the first drive shaft 164 to enter the recessed portion 167 of the engagement portion 166 from above. Therefore, the first part 191 and the second part 192 can be separated in the z direction without detaching the first motor 161 while maintaining the first motor 161 in a state of being supported by the motor support member 180. Since the second rod 173 is in contact with only the second coupling portion 175 of the second drive shaft 174 from a lateral side, it is not necessary to detach the second motor 171 when the first part 191 and the second part 192 are separated from each other. Therefore, the material discharge device 10 can be easily maintained.

In the embodiment, the first part 191 and the second part 192 of the material discharge device 10 are configured to be separable in the Z direction. Since the first part 191 includes the screw 110 and the second part 192 includes the barrel 130, the screw 110 and the barrel 130 can be easily maintained by separating the first part 191 and the second part 192.

In the embodiment, the first hole 146 for accommodating the first heating unit 201 and the second hole 147 for accommodating the first detection unit 202 are formed in the barrel 130, and a direction in which the first hole 146 extends and a direction in which the second hole 147 extends coincide with each other. The heater unit 210 includes the first heating unit 201 and the first detection unit 202, and the first heating unit 201 and the first detection unit 202 are coupled to each other via the fixing member 205. Therefore, since the first heating unit 201 and the first detection unit 202 can be simultaneously detached from or attached to the material discharge device 10, the material discharge device 10 can be easily maintained.

Further, in the embodiment, the third hole 156 for accommodating the second heating unit 203 and the fourth hole 157 for accommodating the second detection unit 204 are formed in the flow path block 141, and a direction in which the third hole 156 and the fourth hole 157 extend coincides with a direction in which the first hole 146 and the second hole 147 are formed in the barrel 130. The heater unit 210 includes the second heating unit 203 and the second detection unit 204, and the second heating unit 203 and the second detection unit 204 are coupled to each other by the fixing member 205. Therefore, in addition to the first heating unit 201 and the first detection unit 202, the second heating unit 203 and the second detection unit 204 can be simultaneously detached from or attached to the material discharge device 10, so that the material discharge device 10 can be easily maintained.

In the embodiment, the second motor 171 holds the second rod 173 at a predetermined position in the second cylinder 172, and the control unit 50 detects pressure of the plasticized material in the flow path 142 based on a torque value of the second motor 171. The material discharge device 10 includes the biasing member 176 that biases the second rod 173 in a direction away from the flow path 142. According to such a configuration, since the second rod 173 is constantly in contact with the second drive shaft 174 of the second motor 171, the pressure in the flow path 142 can be accurately detected. In particular, when small pressure is measured, when the biasing member 176 is not provided, a contact state of the second rod 173 with the second drive shaft 174 is unstable. Therefore, small pressure in particular can be accurately detected by providing the biasing member 176.

For example, when the plasticized material enters between the second rod 173 and the second cylinder 172, a frictional force between the second rod 173 and the second cylinder 172 increases, and the control unit 50 cannot accurately detect the pressure in the flow path 142. In the embodiment, since a constant torque is constantly applied to the second motor 171 by the biasing member 176, it is possible to easily determine whether a pressure detection failure caused by an increase in the frictional force between the second rod 173 and the second cylinder 172 occurs. Such an effect can be described by the following principle.

When the second motor 171 holds the second rod 173 at a predetermined position, the following equation (1) is established in which pressure in the flow path 142 is defined as P (N/mm²), an area of a front end surface of the second rod 173 is defined as A (mm²), a biasing force of the biasing member 176 is defined as K (N), an angle of the second drive shaft 174 is defined as θ(°)=0°, a friction coefficient is defined as μ, a torque value of the second motor 171 is defined as T (N/mm), and an eccentric amount of the second coupling portion 175 is defined as r (mm).

$$[ Fcos ( 90 - θ ) + K ] ( 1 - μ ) = T / r \qquad ( 1 )$$

Here, when the biasing member 176 is not provided, the following four conditions will be discussed. Since the biasing member 176 is not provided, K=0.
1-a) T=0% when P=0 and μ=0
1-b) T=0% when P=0 and μ=0.5
1-c) T=50% when P=10 and μ=0
1-d) T=25% when P=10 and μ=0.5
Values of P and μ are examples.

The torque T is reduced in the condition 1-d) as compared with the condition 1-c). However, whether the reduction is caused by a frictional force or other factors cannot be determined based on only the value of the torque T. This is because, when the pressure P is 0, the torque T is 0 regardless of the value of the friction coefficient μ.

Meanwhile, when the biasing member 176 is provided, K=x (x>0), and the above-described four conditions are, for example, as below.
2-a) T=5% when P=0 and μ=0
2-b) T=2.5% when P=0 and μ=0.5
2-c) T=55% when P=10 and μ=0
2-d) T=27.5% when P=10 and μ=0.5

According to the conditions 2-a) and 2-b), it is understood that the torque T is generated even when the pressure P is 0, and the torque T is reduced when friction is generated. Therefore, when the torque T is reduced in the condition 2-d), it can be determined, based on the result of 2-b), that the reduction caused by friction occurs.

As described above, the control unit 50 can easily determine whether a pressure detection failure caused by a frictional force between the second rod 173 and the second cylinder 172 occurs by providing the biasing member 176 in the material discharge device 10.

### B. Second Embodiment

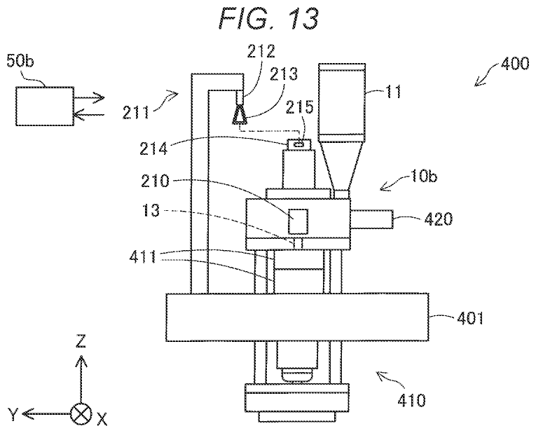

FIG. 13 is a view illustrating a schematic configuration of an injection molding device 400 according to a second embodiment. The injection molding device 400 includes the material supply unit 11, the material discharge device 10b, the nozzle 13, a mold clamping device 410, a plunger mechanism 420, a control unit 50b, the heater unit 210, and the support part 211. In the embodiment, elements denoted by the same reference numerals as those in the first embodiment are the same as those in the first embodiment.

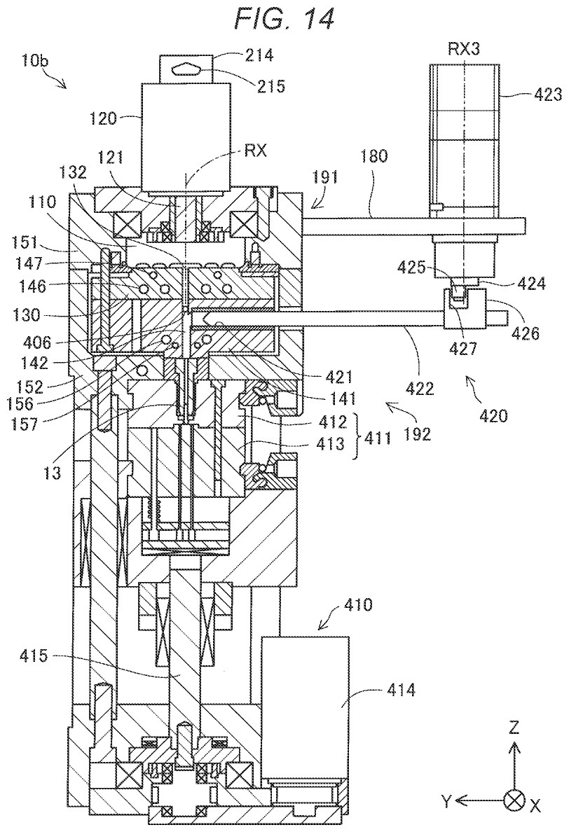

FIG. 14 is a cross-sectional view illustrating the material discharge device 10b and the mold clamping device 410 according to the second embodiment. The material discharge device 10b includes the screw 110, the screw drive motor 120, the barrel 130, and the first coupling portion 214.

The material discharge device 10b further includes the flow path block 141, the flow path 142, a check valve 406, and the plunger mechanism 420. The check valve 406 is provided in the flow path 142 of the flow path block 141, and prevents a reverse flow of the plasticized material from the nozzle 13 side toward the screw 110 side.

The plunger mechanism 420 includes a third cylinder 421, a third rod 422, and a third motor 423. The third motor 423 is fixed to the first part 191 of the material discharge device 10b by the motor support member 180. The third cylinder 421 and the third rod 422 are disposed in the second part 192. The third cylinder 421 communicates with the flow path 142 through which the plasticized material flows. The third cylinder 421 is provided along the Y direction orthogonal to a direction in which the flow path 142 extends. A front end of the third cylinder 421 is coupled to the flow path 142. The third rod 422 slides in the third cylinder 421. A front end portion of the third rod 422 is disposed inside the third cylinder 421, and a rear end portion of the third rod 422 is positioned near a lower side of the third motor 423.

A third drive shaft 424 of the third motor 423 includes a third coupling portion 425 eccentric relative to a rotation axis RX3 of the third drive shaft 424. The third coupling portion 425 is implemented by, for example, a cam follower or a roller follower. An engagement portion 426 is provided near a rear end of the third rod 422. The engagement portion 426 has a recessed portion 427 that engages with the third coupling portion 425.

The plunger mechanism 420 has a function of injecting the plasticized material in the third cylinder 421 into a mold 411. The third rod 422 is driven by the third motor 423 and is moved inside the third cylinder 421 in a direction away from the flow path 142 to suction and measure the plasticized material into the third cylinder 421. Thereafter, the third rod 422 is moved inside the third cylinder 421 in a direction approaching the flow path 142 to deliver the plasticized material to the flow path 142. The plasticized material delivered to the flow path 142 is pressure-fed to the nozzle 13 and injected from the nozzle 13 into the mold 411.

Similar to the first embodiment, the first holes 146 and the second holes 147 are formed in the barrel 130. Similar to the first embodiment, the third holes 156 and the fourth holes 157 are formed in the flow path block 141. The first heating unit 201 is inserted into the first hole 146, the first detection unit 202 is inserted into the second hole 147, the second heating unit 203 is inserted into the third hole 156, and the second detection unit 204 is inserted into the fourth hole 157 by coupling the heater unit 210 illustrated in FIG. 6 to the material discharge device 10b.

Similar to the first embodiment, the material discharge device 10b is configured such that the first part 191 and the second part 192 are separable. Similar to the first embodiment, the first coupling portion 214 is provided at an upper end of the material discharge device 10b. Other configurations of the material discharge device 10b are the same as those of the material discharge device 10b in the first embodiment.

The mold 411 includes a fixed mold 412 and a movable mold 413. The fixed mold 412 is fixed to the material discharge device 10b. The movable mold 413 can be moved forward and backward by the mold clamping device 410 in a mold clamping direction relative to the fixed mold 412. The plasticized material generated by the material discharge device 10b is injected from the nozzle 13 into a cavity defined by the fixed mold 412 and the movable mold 413. The mold 411 may be made of metal, resin, or ceramic.

The mold clamping device 410 includes a mold drive unit 414. The mold drive unit 414 includes a motor, a gear, and the like, and is coupled to the movable mold 413 via a ball screw 415. The mold clamping device 410 drives the mold drive unit 414 under the control of the control unit 50b to rotate the ball screw 415 and move the movable mold 413 relative to the fixed mold 412 to open and close the mold 411.

As illustrated in FIG. 13, the support part 211 is fixed on a base 401 of the injection molding device 400. Similar to the first embodiment, the support part 211 suspends the first part 191 of the material discharge device 10b by hooking the second coupling portion 213 fixed to a lower end of the spring 212 into the opening 215 of the first coupling portion 214 of the material discharge device 10b.

According to the second embodiment described above as well, it is possible to prevent thermal expansion of a device accompanying with plasticization from hindering an operation of the third rod 422, as in the first embodiment. The injection molding device 400 according to the second embodiment may include the pressure detection mechanism 170, as in the three-dimensional modeling device 100 in the first embodiment.

### C. Other Embodiments (C1)

In the above-described embodiments, the first part 191 and the second part 192 are configured to be separable from each other. Alternatively, the first part 191 and the second part 192 may be configured to be not separable from each other.

(C2) Each of the three-dimensional modeling device 100 and the injection molding device 400 according to the above-described embodiments includes the first coupling portion 214, the second coupling portion 213, and the support part 211 for suspending the first part 191 separated from the second part 192. Alternatively, each of the three-dimensional modeling device 100 and the injection molding device 400 may not include the first coupling portion 214, the second coupling portion 213, and the support part 211.

(C3) In the above-described embodiments, the screw 110 is disposed in the first part 191, and the barrel 130 is disposed in the second part 192. The first part 191 and the second part 192 are not limited to such a configuration. For example, the first part 191 may include the screw 110 and the barrel 130, and the second part 192 may not include the barrel 130.

(C4) In the above-described embodiments, the heater unit 210 is configured to be detachable from the plasticizing unit 12. Alternatively, the heater unit 210 may be not detachable from the plasticizing unit 12. Further, the heating units and the detection units constituting the heater unit 210 may not be coupled by the fixing member 205.

(C5) In the above-described embodiments, the material discharge device 10 includes the biasing member 176 that biases the second rod 173 in a direction away from the flow path 142. Alternatively, the material discharge device 10 may not include the biasing member 176.

(C6) In the above-described embodiments, the three-dimensional modeling device 100 includes two material discharge devices 10. Alternatively, the three-dimensional modeling device 100 may include one or three or more material discharge devices 10.

### D. Other Aspects

The present disclosure is not limited to the embodiments described above, and can be implemented in various aspects without departing from the gist of the present disclosure. For example, technical features of the embodiments described above corresponding to technical features in the embodiments to be described below can be replaced or combined as appropriate in order to solve a part or all of problems, or in order to achieve a part or all of effects described above. The technical features can be deleted as appropriate unless described as being essential in the specification.

(1) According to a first aspect of the present disclosure, a material discharge device is provided. The material discharge device includes: a first part including at least a part of a plasticizing unit configured to plasticize a material to generate a plasticized material; a second part including a cylinder configured to communicate with a flow path through which the plasticized material flows, a rod configured to slide in the cylinder, and a nozzle configured to discharge the plasticized material; and a motor fixed to the first part and configured to operate the rod, the first part and the second part are arranged in a first direction, and the rod engages with a drive shaft of the motor in a manner of allowing the rod to move along the first direction. According to this aspect, it is possible to prevent thermal expansion of the device accompanying with plasticization from inhibiting an operation of the rod.

(2) In the material discharge device in the above-described aspect, the first part and the second part may be configured to be separable in the first direction, the plasticizing unit may include a screw having a groove forming surface on which a groove is formed, and a barrel which has a facing surface facing the groove forming surface and on which a communication hole for communicating with the nozzle is formed, the first part may include the screw, and the second part may include the barrel. According to this aspect, maintenance work of the screw or the barrel can be facilitated.

(3) The material discharge device of the above-described aspect may further include: a first heating unit disposed in the barrel and configured to heat a material supplied to the groove; and a first detection unit disposed in the barrel and configured to detect a temperature of the groove, in the barrel, a first hole for accommodating the first heating unit and a second hole for accommodating the first detection unit may be formed, a direction in which the first hole extends may coincide with a direction in which the second hole extends, and the first heating unit and the first detection unit may be coupled to each other via a fixing member. According to this aspect, since the first heating unit and the first detection unit can be simultaneously detached or attached to the device, the device can be easily maintained.

(4) In the material discharge device according to the above-described aspect, the drive shaft may include a coupling portion eccentric relative to a rotation axis of the drive shaft, the rod may include an engagement portion on which a recessed portion that is recessed in the first direction and engages with the coupling portion is formed, the material discharge device may further include a control unit configured to control the motor to rotate the coupling portion about the rotation axis and cause the rod to slide in the cylinder, thereby performing a suction operation of suctioning the plasticized material into the cylinder and a delivery operation of delivering the suctioned plasticized material to the flow path, and a depth of the recessed portion may be a depth at which the coupling portion engages with the recessed portion in both a case where the rod is displaced and a case where the rod is not displaced in the first direction due to thermal expansion of the first part and the second part. According to this aspect, even when the device thermally expands, the suction operation and the delivery operation of the plasticized material can be reliably performed.

(5) In the material discharge device according to the above-described aspect, the motor may be operated such that the rod is held at a predetermined position in the cylinder, and the material discharge device may further include a control unit configured to detect pressure of the plasticized material in the flow path based on a torque value of the motor; and a biasing member configured to bias the rod in a direction away from the flow path. According to this aspect, the pressure in the flow path can be accurately detected.

(6) According to a second aspect of the present disclosure, a three-dimensional modeling device is provided. The three-dimensional modeling device includes the above-described material discharge device; and a stage disposed in a manner of facing the nozzle.

(7) In the three-dimensional modeling device according to the above-described aspect, the first part and the second part may be configured to be separable in the first direction, the first part may include a first coupling portion, and the three-dimensional modeling device may further include a support part that includes a second coupling portion and configured to suspend the first part by coupling the first coupling portion and the second coupling portion. According to this aspect, since the first part can be suspended from the support part, the three-dimensional modeling device can be easily maintained.

The present disclosure is not limited to the material discharge device and the three-dimensional modeling device described above, and can be implemented in various aspects such as an injection molding device including the material discharge device and a material discharge method.

What is claimed is:

1. A material discharge device comprising:
a first part including at least a part of a plasticizing unit configured to plasticize a material to generate a plasticized material;
a second part including a cylinder configured to communicate with a flow path through which the plasticized material flows, a rod configured to slide in the cylinder, and a nozzle configured to discharge the plasticized material; and
a motor fixed to the first part and configured to operate the rod, wherein
the first part and the second part are arranged in a first direction, and
the rod engages with a drive shaft of the motor in a manner of allowing the rod to move along the first direction.

2. The material discharge device according to claim 1, wherein
the first part and the second part are configured to be separable in the first direction,
the plasticizing unit includes
a screw having a groove forming surface in which a groove is formed, and
a barrel which has a facing surface facing the groove forming surface and on which a communication hole for communicating with the nozzle is formed,
the first part includes the screw, and
the second part includes the barrel.

3. The material discharge device according to claim 2, further comprising:
a first heating unit disposed in the barrel and configured to heat a material supplied to the groove; and
a first detection unit disposed in the barrel and configured to detect a temperature of the groove, wherein
in the barrel, a first hole to accommodate the first heating unit and a second hole to accommodate the first detection unit are formed,
a direction in which the first hole extends coincides with a direction in which the second hole extends, and
the first heating unit and the first detection unit are coupled to each other via a fixing member.

4. The material discharge device according to claim 1, wherein
the drive shaft includes a coupling portion eccentric relative to a rotation axis of the drive shaft,
the rod includes an engagement portion in which a recessed portion that is recessed in the first direction and engages with the coupling portion is formed,
the material discharge device further comprises a control unit configured to control the motor to rotate the coupling portion about the rotation axis and cause the rod to slide in the cylinder, thereby performing a suction operation of suctioning the plasticized material into the cylinder and a delivery operation of delivering the suctioned plasticized material to the flow path, and
a depth of the recessed portion is a depth at which the coupling portion engages with the recessed portion in both a case where the rod is displaced and a case where the rod is not displaced in the first direction due to thermal expansion of the first part and the second part.

5. The material discharge device according to claim 1, wherein
the motor is operated such that the rod is held at a predetermined position in the cylinder, and
the material discharge device further comprises:
a control unit configured to detect pressure of the plasticized material in the flow path based on a torque value of the motor, and
a biasing member configured to bias the rod in a direction away from the flow path.

6. A three-dimensional modeling device comprising:
the material discharge device according to claim 1; and
a stage disposed in a manner of facing the nozzle.

7. The three-dimensional modeling device according to claim 6, wherein
the first part and the second part are configured to be separable in the first direction,
the first part includes a first coupling portion and
the three-dimensional modeling device further comprises a support part that includes a second coupling portion and configured to suspend the first part by coupling the first coupling portion and the second coupling portion.
